(19) United States
(12) Patent Application Publication
(10) Pub. No.: US 2024/0316750 A1
(43) Pub. Date: Sep. 26, 2024

(54) Universal Pneumatic Tool Storage Device

(71) Applicant: Andrew Konesky, Calgary (CA)

(72) Inventor: Andrew Konesky, Calgary (CA)

(21) Appl. No.: 18/260,009

(22) PCT Filed: Jan. 3, 2022
(86) PCT No.: PCT/CA2022/050001

§ 371 Date: Jul. 7, 2022

(30) Foreign Application Priority Data
Jan. 2, 2020 (US) 63133300

(51) Int. Cl. B25H 3/00; F16B 21/16

(52) U.S. Cl. CPC B25H 3/006; F16B 21/165

(57) ABSTRACT

An apparatus configured for attaching an air-powered accessory to a surface by which the apparatus may be installed and secured by the single act of inserting the accessory into the apparatus and by which the accessory may be removed from the apparatus by depressing the apparatus collar. The apparatus is attachable to a surface by bolt, screw, or other attachment means passing into the device substantially co-axially with the device.

### TECHNICAL FIELD

This invention relates to apparatuses for selectively attaching pneumatic tools to a surface for storage and retrieval.

### BACKGROUND ART

Currently, there are a limited number of storage options for pneumatic tools given the wide variety of shapes and sizes along with the very diverse environments in which they are found. The sizes can range from a small air chuck up to a large roofing nail gun and beyond. This presents the challenge of finding a solution that works for most forms of pneumatic equipment. In addition, some tools use cutting accessories such as drill bits and cutting disks which can be damaged if not protected properly. Pneumatic tools are used in a wide variety of settings ranging from home use, to automotive & aircraft repair shops, outdoor roofing applications, to mobile repair trucks and vans, race tracks, to furniture manufacturing, commercial/industrial settings and factories. A stationary shelf may work well in a home garage or automotive shop, but it may not be suitable for use in a mobile repair van or factory floor without walls and only using mobile carts.

The most common storage solutions for pneumatic tools include shelves, toolboxes and custom shelving racks. Shelves or workbenches provide flat surfaces where tools are simply placed. When tools are simply placed on a flat surface they, and their attached accessories may be damaged by impact or contact with other tools or the surface. Flat surface storage also requires significant space and generally is only suitable along a wall or something resting on the floor, such as a shelving unit thereby occupying significant floor space. Flat surface storage can easily lead to disorganization, inefficiency, and poses a risk of the equipment falling resulting in permanent damage or catastrophic failure.

Toolboxes (including tool bags and tool chests) are another common storage solution for pneumatic tools. While toolboxes provide significant protection over exposed flat surface storage, often the tools are loosely placed into a drawer or container where they may be damaged and abraded against one another and other tools or equipment inside the drawer and may be difficult to locate. This isn't always practical in the various work environments. Further, when stored loosely in drawers, the tools can be disorganized and be lost or missing. Custom shelving racks are another conventional storage option, these most commonly resemble an L shaped piece of metal or plastic mounted on a wall with channels cut in it resembling a rake of sorts. The shelf is designed to hold the male plugs by their narrow recess that normally accommodates the locking ball bearings. This storage method relies on gravity to keep tools suspended and stationary. Nothing prevents the tools from coming loose and falling if bumped or moved. It also requires an adjacent wall to be installed on, the ability to accommodate different shapes and sizes of tools is limited, often holding the tools too close to the wall preventing larger tools from fitting, tool spacing is fixed which is not ideal for various shapes and sizes, it isn't suitable for a mobile application such as a repair truck where equipment is bounced around, and racks of these types are generally not modular. A shelving rack generally has a fixed number of slots with fixed spacing, if holding a larger tool, this tool may block access to several adjacent slots and limit the number of tools the rack can hold.

Pegboards are often used in workshops to help keep track of tools but the hooks are not designed for holding heavy or oddly shaped pneumatic tools. It also requires a large amount of room and custom construction. Hooks placed to hold tools frequently come loose when the tools are accessed and tools balance on the hooks which can result in falls, drops or damage.

Another option for mounting tools is by arranging vertical pegs or screws rising up from a horizontal surface that allows the tools to sit on. This is problematic because the pegs can cause damage to the tools directly. Within the tools, there are filter screens and other delicate components that can be damaged from inserting foreign objects inside the air inlet. This storage method also relies on gravity and can result in accidental damage if bumped, knocked over or if the tools fall off.

There are a number of quick connect coupler standards which creates another problem. While one rack may work with male plugs of a certain standard, it may not work with others of a different standard (L-style versus V-style). A consumer must pay attention to the plug they use and ensure the storage rack they are considering will accommodate that standard.

In mobile repair vehicles, there are no practical solution to store tools without damage when experiencing the bumps and vibrations of road and off-road travel. Having tools stored in a bin, compartment or toolbox will lead to damage of the equipment through abrasion and impact. Custom made compartments with foam inserts to envelop the tools would be the only truly protective solution but are expensive, take up significantly room, and must be made specific to each individual tool type/shape/size which is not practical.

A conventional coupler could be mounted to hold a tool but there exist a number of problems with this as well. The standard threads on a coupler are NPT (National Pipe Thread) which is tapered or conical. Common bolts and nuts are not available with this thread so a creative method of fixing the couplers is required and may not be secure. In short, these couplers are designed to be installed on air hoses with a proprietary connection, not mounted to a surface or object for the purpose of holding a tool. Many of these couplers also feature a limited number of retaining ball bearings which may insecure in stressful applications or for horizontal installation. Finally, a pipe nipple and cap could be installed in the coupler for mounting purposes but this would be cumbersome and take up too much room with a large cap protruding opposite the coupler which would not be suitable for installation on a mobile cart, tool bench or shelf. This option would also be cost prohibitive as it would involve the cost of the coupler, plus additional parts for mounting.

In addition, the majority of couplers have a “two touch” system requiring the outer collar to be manipulated prior to the tool being inserted. This two handed function would significantly reduce the utility and convenience of a holder.

These common solutions mentioned above and other current solutions fail to meet the needs of the industry because they are often cumbersome, cost prohibitive, limited to housing specific sized or shaped tools, take up substantial space, not locking, offer limited protection, don't universally fit the full range of tools available, or restrict access to stored tools. Further, many of these options limit easy access to the stored tools requiring both hands and numerous steps to access the tool when required.

### SUMMARY OF INVENTION

The present invention is directed to a universal locking pneumatic tool storage device. In its most complete form, the device comprises a tool mount and a surface mount. The tool mount preferably resembles a mountable standard female pneumatic quick coupler configured to accept and securely lock in place a matching male plug. A male plug is commonly installed in the standard ¼″ Female National Pipe Thread (FNPT) port commonly found on pneumatic tools and when the male plug is engaged with the female coupler (device), the tool is retained by the coupler. The surface mount preferably comprises of a first body member by which the device is secured to a surface or object using either a bolt or screw(s). The device functions as a secure holder to store and hold a pneumatic tool. The device can additionally be used as a protective cover when engaged on the male plug installed on a tool but not mounted to a surface.

On the first body member of the device, the mounting surface (opposite the engagement surface/port) is preferably configured with standard bolt thread and is used to secure the device to a surface or object. Most commonly, the bolt size will be M6 1.0 thread, but can also be ¼″ 20TPI or any other common bolt size suitable for holding the device and associated tools. In the preferred version, the threaded bolt hole passing through the first body member of the device has an internal diameter slightly larger than the outside diameter of the threads on a common screw yet smaller than the outer diameter of the screw head. This serves to allow a screw shank to pass through the threaded bolt hole without resistance but the head of the screw will catch and hold the device when screwed into a wall or object. This allows the device to be installed using either a bolt or screw. The first body member of the device is preferably chamfered to accommodate the screw head for further stability. The center of the device preferably has a hollow diameter configured to allow the screw head to pass through the engagement port and seat deeper into the device against the inside of the first body member. This requires the valve, commonly found in a conventional pressure-bearing female quick coupler, be replaced or removed so a passage exists for the screw. Because the primary function of this device is to mechanically hold the male plug securely but not hold air pressure, the valve and associated seals can be removed without affecting the device's utility as a tool holder.

A spring and a hollow sleeve reside in the tool mount and the hollow sleeve extends along the inside wall of the second body member. The purpose of this hollow sleeve or “valve bore” is to function as a ball bearing restrictor. Under normal operation, the sleeve is pushed by the spring towards the engagement port. As the sleeve slides up the inside wall of the second body member, it pushes the locking ball bearings outwards. With the ball bearings in their outward position, the outer locking collar is restricted from moving to its furthest position towards the engagement port. The outer locking collar is under spring pressure and “cocked”. As a male plug is inserted into the device, the plug pushes the inner sleeve further into the second body member towards the mounting surface. Once the sleeve is out of the way of the locking ball bearings, the ball bearings are allowed to move inwards until they contact a recess(es) on the plug. After the ball bearings move inward, an outer locking collar with a tapered inner surface is free to completely move toward the engagement surface to its final position locking the ball bearings in their inward position and mechanically locking the male plug in place.

To release a tool from the device, the outer collar is pushed toward the mounting surface compressing the spring which allows the locking balls to move outward by the tapered surface of the plug pushing on them. The spring from the inner sleeve pushes the plug out to eject it and as the sleeve slides up, it locks the ball bearings in their outward position and thus locks the outer collar back to its cocked position. By locking in a cocked position, a tool plug can be inserted and locked in place without requiring any device manipulation. This gives the device an automatic locking function by simply inserting the plug. Sliding the outer collar back releases the tool and resets the automatic locking mechanism.

The hollow sleeve allows the head of a screw to pass through the device without restriction along with a screw driver, drill bit, or driver shank to operate the screw within the plug allowing it to be installed. This differs from current designs with a valve in the center that has one or more seals and holds pressure. In a preferred embodiment, the bottom of the sleeve also has a landing shoulder to accommodate the inner spring and centralize the spring on the sleeve. There are also preferably small chamfers on the other end towards the engagement port to facilitate the engagement of the plug and assist with pushing the ball bearings to their outward position.

The overall body length of the device can vary but is preferably as short as possible while still providing secure holding function. The overall length will be affected by the length of the plug it is designed to hold and the type of surface mount. The ball bearings used to mechanically hold the plug can vary in number but in the ideal version the number is 6 or more to provide even pressure on many points around the plug. This becomes particularly important when installed horizontally for stabilization.

Another defining feature of this device is its ability to accommodate multiple common plug types allowing a universal function. This is not strictly required to function as a holder, individual designs can be developed for each coupler combination however removing the need to hold air pressure allows for a simplified design appealing to all five common types of similar couplers used in North America and Europe at the time of this writing. The inner sleeve is sized to ensure each of the five plugs catch the inner sleeve and depress it against the spring to allow the ball bearings to enter the engagement port and lock the plug in place. For other dis-similar designs with different proportions, such as the common Nitto style used in Asia, a modified design may be used however the function remains the same. This is also true for other less commonly sized quick connect plugs such as ⅜″ or ½″. The preferred embodiment accommodates many varieties of plugs including styles referred to as M (I/M, Industrial, ISO 6150B), A (ARO 210), T (Truflate, Automotive), V (European, High Flow), L (Lincoln).

None of the features described above are required for the device to function as a holder; it can still hold tools and equipment if doesn't have a bore through the center, or a threaded hole, or if it uses a manual design without the inner spring and sleeve. It doesn't have to accommodate multiple types of plugs, or multiple types of mounting methods. It may optionally have external mounting features. These features all make the device more universal and appealing to the customer but are not required for the device to function as a holder and storage device. Overall the function of the device described is to securely lock and hold tools in place relative to a surface or object the device is mounted to, as a mounting system or dock for storage which is a novel use for this type of connection and includes proprietary design changes to a conventional coupler to facilitate mounting, accommodate multiple plug designs, and simplify design by omitting the need to hold pressure. The present apparatus is distinguishable from present devices in that it does not contain a valve and has a hollow center for mounting.

All of the described features are included in the design of the device primarily made up of a two-part cylindrical body with an optional flange on one end, holes for ball bearings, and threads to attach to the first body member. The first body member will preferably have a threaded bolt hole passing through, have threads for the second body member to screw into, and a chamfer for a screw head. There will also be an inner spring and inner hollow sleeve, an outer collar and spring, and 6 ball bearings. There may optionally be rubber seals and O-Rings to provide friction and cushion. All of these components assembled form the device as one mechanical apparatus with moving parts that accepts engagement from a corresponding plug and has the ability to mechanically lock the apparatus in place securely.

In its most complete form, the device is usable mounted or unmounted, it can be mounted using a bolt or screw(s), it can accommodate multiple standards of quick connect plugs, it is designed to allow ‘automatic’ hands free locking and single touch unlocking, and it is designed with a hollow center to allow a screw to pass through the second body member into the bottom of the first body member and need not hold air pressure. Further, the device will hold the plug (and tool) securely preventing damage and unintentional disengagement. Using a coupler as a holder and storage device with design elements to facilitate this, it is a novel application of a quick connect coupler.

This device assembly is made up of two halves roughly equal in size as seen in FIGS. 1, 2 & 3; the first body member (301) and the second body member (201). Inside the assembly are the inner sleeve spring (601), the sleeve itself (401), and six locking ball bearings (801). On the outside, a rubber O-Ring (901) helps to seal the two halves together preventing them from coming apart, along with the outer collar spring (701) and the outer collar (501) which helps keep the ball bearings in place and locks them in their inner position when fully positioned against the flange at the engagement end. Finally, the image shows a completely assembled device on the right side (101). More detail on each of the components will be described in the following figures and descriptions.

The first body member (301) itself has been significantly modified from the version found on conventional pneumatic couplers in order to facilitate the new function of holding equipment without requiring an air seal. The exterior of the first body member in this embodiment remains in a hex (302) shape to allow a wrench to be engaged with it to facilitate mounting using a bolt. This shape is common although different versions of the device may move away from hex shaped body and could instead feature an external mounting flange (313—not pictured here) or a multitude of different shapes depending on the installation application. In short, the hex shape is featured here but not required and may vary. The hex shape can facilitate mounting using a bolt however when mounting the device using a screw(s) no purchase is required on the outside of the body and thus could be round or any other suitable shape.

Within the first body member in this version, there is a chamfer (303) on the inside of the bore at the base of the first body member. This chamfer functions as a countersunk feature to accommodate the head of a screw as an attachment method. The device may not always require screws for mounting and this feature is optional although it adds functionality when using a flat style screw mounted installation. On the end opposite the mounting surface (103), exists a recess for the outer collar (304). This recess is simply described as a surface that has a smaller outside diameter than the rest of the first body member (302) in this version. In some variations, this OD may exceed that of the rest of the first body member but the important distinction is that the OD of this area has to be smaller than the internal diameter (ID) of the outer collar (501) such that the outer collar can slide over this portion and travel freely along the Z-axis of the device without hindrance. There is a land (315) for the outer collar that functions as a physical stop to prevent the outer collar from traveling too far. This feature combine with the flange (205) on the second body member (201) provide a limited path for the outer collar to travel while containing it.

Relating to the outer collar (501) is the land (305) for the outer collar spring (701). This land, or feature allows the outer collar spring to fit over the end of the first body member and engage as far as the land. The OD of the wall adjacent to the land must be less than that of the ID of the spring to fit properly. This land feature (305) is recessed enough so that the outer collar spring does not impede the movement of the outer collar, and also serves as a stable base for the spring to press against in order to generate potential energy when compressed. The outer collar spring is contained between this land (305) and the one inside the outer collar (506).

The first body member (301) forms one half of the assembly's main structure, which is connected to the second body member (201). To connect the two components, threads (306) are used in this example to screw the two body members together. Having the assembly disassemble into multiple pieces facilitates assembly, simplifies manufacturing and provides the ability to install the internal components such as the inner sleeve (401) and inner sleeve spring (601), as well as install the outer components such as the outer collar (501), the outer collar spring (701) and the ball bearings (801). The thread standard used is not important, only that it matches on both components and is suitable for the application (allows the device to come together properly without impeding operation). In this example, the thread is M18 1.0.

Adjacent to the threads (306) on the first body member there is preferably a recess (314) for an O-Ring (901) that corresponds with a recess (203) on the second body member. When the first body member and second body member components are fully screwed together, an O-Ring is compressed in a groove helping to seal the apparatus and keep the two halves together. The O-ring and this feature is optional and a vestige of the conventional coupler design. Omitting the O-Ring from the assembly does not negatively affect the apparatus function.

Inside the first body member, there is a void or space in the area conventionally reserved for a valve, seal, and valve spring. This void (307) is now used to house the inner sleeve (401) and inner sleeve spring (601) as well as accommodate the tips of longer plugs that may be inserted and allows for the device to accommodate the head of a screw without obstructing function, It allows a screw to pass through the first body member to arrive at its final installed location, as well as the tip of a driver to install the screw. This void is crucial for the internal components to be installed and for the overall operation.

Inside the first body member, there is a flat area that functions as the land (308) for the inner valve spring. This land helps centralize the spring and provides a surface for the spring to push against to build potential energy. The spring resides between this land, and the land on the bottom of the inner sleeve (404).

The ‘bottom’ of the first body member features the most common location for the mounting surface (103) which is a flat area that most commonly comes in contact with a surface or object the device will be mounted to. For stability, it is desirable to maximize the surface area so any chamfers, fillets or design elements commonly found on the outside edge or corner of a conventional pneumatic coupler to reduce sharp edges have been removed (309). Alternate versions of this device (FIG. 11) may include different mounting features such as an external mounting flange (313) which may be molded into the first body member. This would increase the surface area for mounting and provide easy external access to screw or bolt holes (104).

The bottom mounting surface (103) of the first body member also features a mounting bore (312) which, in this example, passes through the first body member. This mounting bore is preferably threaded (311) with common parallel bolt threads providing an attachment method to fix the device in place relative to a surface or object. To help facilitate installation, there is preferably a small inner chamfer (310) that assists in bolt alignment and starting the threading process. The bore, in this example with M6 1.0 threads, has a dual purpose and can either be used with a bolt, threaded in from the mounting surface side, or it can allow a screw to pass through from the opposite direction. This mounting bore along the Z-axis of the device is one example of an attachment method but the device is not limited to this. As mentioned, the device can optionally feature an external mounting flange (313), a bore that passes through the component in some other orientation or location, it may use some other feature to be mounted such as a hook or embedded magnet, or it can lack a bore and be used exclusively as a protective cap for the plug and tool it is installed on. Notably, the mounting surface (103) does not have to be flat, or perpendicular to the Z-axis of the device, it can take many forms to facilitate mounting in different environments and to differently shaped surfaces.

These mounting features are completely unique to this design and device, especially the ability to use the same bore for multiple methods of installation. In total, all of these features contribute to the ability to use the device to hold and store pneumatic tools using the convenience of a quick coupler function often already found installed on tools. The use of a coupler in this manor is completely novel and may not be limited to just pneumatic applications.

The second body member (101) makes up the other primary half of the assembly which gets threaded together with the first body member (301) portion and houses the rest of the components. The threads (202) used to combine the first body member and the second body member must mate, but can be any size or style appropriate for the application. In this example, standard M18 1.0 threads have been used, but it should be obvious to one having ordinary skill in the art other thread patterns may be used and are within the scope of the present invention. Adjacent to the threads is a recess (203) to accommodate a sealing O-Ring and forms the complimentary recess (314) on the first body member. The original purpose of this O-Ring was to retain pressure however since this device's described function is significantly different, the O-Ring and related recesses are no longer required. There are some secondary benefits from leaving the O-Ring in the design, and that is to cushion the joint between the second body member and the first body member as well as to provide some friction resistance helping to prevent the two halves from unscrewing unintentionally. For this reason, the O-Ring (901) has been left in this design. Additionally, by not altering this component significantly, no customization is required and standard components can be used to help lower production costs.

The next major feature of the second body member is the tapered ports (204) for the ball bearings (801) which provide the mechanical locking action for inserted plugs and form part 300 of the retention system. Three things worth mentioning:
1) The number of ball bearings used can vary from few to many. In theory as few as one or two could be used although this would provide an uneven distribution of force on the plug and it would have too much wobble or play. A minimum number of ball bearings for stability would be three although more enhance the strength and stability of the connection. The device pictured in the diagram features four evenly spaced ball bearings, but the described device uses six ideally to enhance holding power. This device may optionally be installed in a horizontal orientation which means there would be a significant amount of side loading on the bearings. This force is better addressed and distributed evenly with a greater number of ball bearings.
2) The size of the ball bearings can vary provided they have enough holding force for the device to function properly. There are multiple sized ball bearings used in existing pneumatic couplers, in this design we have opted for the larger of these sizes for more strength and security since the function is to support the weight of a tool and accessory in multiple orientations. The ball bearing has to be large enough that when in the locked position, the curved surface extending in to the second body member's bore (209) is enough to engage with, and hold, the plug. The ball is pushed in and held in its inner position by the outer collar so the ball bearings must be large enough to secure a plug while still in contact with the collar in its locked position. If the ball bearings are too large, they would be unable to move fully out of the way of the engaging plug and would prevent the plug from becoming seated and locked. Contrarily, if the ball bearings are too small, the outer collar will not push them far enough inward to secure the plug. To simplify the device, common sized ball bearings are used.
3) The third detail is the position of the ball bearing ports (204). While it is most common for the ports to be spaced evenly around the circumference of the second body member (uneven spacing would result in uneven force applied, it's optional but not ideal in this case), their location closer to, or further from, the engagement surface plays a role in how the plugs are held. This can be optimized by moving the ports further from the engagement surface (102) and flange (205) which in effect holds the plug deeper in the coupler and offers more support.

One final note on the locking ball bearing ports, they have a tapered shape allowing the balls to move freely outward towards the exterior of the second body member (away from the Z-axis) but when pushed in, the final ID of the port nearest to the center bore (209) is smaller than the OD of the bearing at its widest point. This means the ball bearing can move towards the center bore creating a partial obstruction but not completely pass into the bore and become unseated. When installed in the final assembly, the ball bearings are trapped within the tapered port with the outer collar (501) being the outer blockage. In addition to the inner sleeve (401), the inner sleeve spring (601), the outer collar (501), the outer collar spring (701) and the ball bearings (801), the tapered ports (204) form the final component of the retention system that securely locks a male plug in place.

Forming part of the engagement surface (102), a flange (205) feature is present on the second body member. This flange serves the important purpose of retaining the outer collar (501) in place and preventing it from falling off and releasing the ball bearings. It is also the surface facilitating assembly of the second body member to the first body member.

FIG. 3 illustrates the engagement surface (102), sometimes referred to as the engagement port. This is the bore or void created to accommodate the male coupler plug. It is typically cylindrical in nature and mimics the rough dimensions of the plugs it is used with. In the case of a universal coupler, the ID dimensions of the device must be close to the OD of the various plugs it will work with. Most importantly, the wider retaining ring molded on a plug must fit through the ID of the device (209), the plug must engage far enough into the device for the recess on the plug to reach the ports for the ball bearings, and the ball bearings must extend far enough into the bore (209) to lock the plug in place and prevent the ring from passing the extended ball bearings (801) unintentionally. Around the mouth of the engagement port (209), there is a small chamfer (206) that assists with plug insertion by guiding the plug towards the center of the port.

Another important detail in the second body member is the land (207) for the inner sleeve. Towards the start of the bore (209) in the engagement surface (102), the ID of the bore narrows slightly forming the land. This prevents the sleeve from extending too far and falling out of the second body member. Ideally, the land is aligned with the edge of the ball bearing ports so when the inner sleeve spring (601) is fully extended, the inner sleeve (401) completely blocks the ball bearings from moving into the center bore which allows the plug to be engaged without manipulation of the outer collar. Moving the location of the ball bearing ports would require an adjustment of the land position for the inner sleeve.

Finally, the outer surface of the second body member (208) forms the guide structure for the outer collar to ride along. The OD of this surface should compliment the ID of the outer collar, and should match the OD of the first body member (304) where the outer collar resides. It also centralizes the outer collar spring (701) so it can only move axially.

Together, these features make up the second body member of the assembly (101) and help achieve the holding function, they form the engagement surface (102), and are instrumental in achieving the automatic function which improves the apparatus' functionality.

The inner sleeve spring (601) resides primarily inside the first body member (301) resting on the inner bore (308) and applying pressure directly to the inner sleeve (401) via the land (404) and is kept centered by the rim around the bottom of the sleeve (405). When a plug is inserted into the device, this spring is compressed and potential energy is stored to assist with ejecting the plug when intentionally released. When not compressed, the spring serves to hold the inner sleeve in its fully extended position towards the engagement surface (102) against the sleeve land in the second body member (207). The spring is preferably tapered/conical allowing it to collapse further but is not required. Typically the material used is 1.2 mm spring wire although this can also vary. The narrowest ID of the spring coil must be large enough to accommodate the OD of the mounting screw head. Finally the OD of the spring must also fit within the bore of the first body member so it seats properly within the land (308).

The outer collar spring (701) resides inside the outer collar (501) and outside (304) of a portion of the first body member and second body member (208). The spring is trapped between the land (305) on the first body member and the land (506) on the outer collar. The ID of the coil must be great then the OD of the first body member and the second body member but the coil OD must be less than the ID of the outer collar. The spring is commonly made up of spring wire with a diameter of 1 mm but this can vary depending on the desired amount of force. The length of the spring at rest should be longer than the allocated space such that it always exerts force on the outer collar. This force is adjustable by changing the parameters of the spring.

The ball bearings (801) form an integral part of the retention system. The ball bearing size can vary but common sizes work fine for this application provided the tapered ports (204) are designed for that size bearing. It is important for this design that the bearings be spherical although other designs may see a variation of this shape or a replacement of bearings entirely with pins or other common locking mechanisms.

Finally, the rubber O-Ring (901) in FIG. 4 is a vestige of the pressure bearing pneumatic coupler. While it is not strictly required for this device, it has been left in place to provide marginal benefits such as providing resistance to the first body member and second body member connection so it does not loosen accidentally. The O-Ring size is appropriate for the recess (314) formed in the first body member and the second body member (203).

The inner sleeve in FIG. 5 is one of the most unique parts of this device assembly (101), it has been designed completely from scratch and is partially responsible for the complete change of use of a common pneumatic coupler. The sleeve is critical for the automatic function of the coupler holding device and for retaining and locking in place an inserted plug.

A conventional pneumatic coupler contains a valve (098) and associated seals enabling the coupler to hold pressure. In this device, the purpose is no longer to hold air pressure so the valve and seals are removed completely. Because the inner sleeve spring (601) normally applies force to the valve, and the valve provides the ball bearing retention function in an automatic design, a different component had to be created to serve those functions with the valve removed. It should be mentioned that the valve was removed from the device in order to eliminate the blockage the valve posed, creating a hollow passage (099) to facilitate mounting.

The sleeve itself has a number of features to assist with its function. There are two distinct ends to the sleeve, which we will refer to as the engagement end and the mounting end. The outside of the engagement end has a very small chamfer (402) built in to the design in order to help direct and guide the ball bearings outward towards the outer collar. This resets the automatic action allowing a new plug to be inserted without restriction and lock in place without having to manipulate the outer collar. Without this chamfer, the sleeve can act as a guillotine resulting in the ball bearings being wedged in place, temporarily pausing the function of the device. This tiny feature keeps the device running smoothly and self-resets.

Similarly, there is a larger chamfer (403) on the inside of the same end to help guide the tip of a plug in to the engagement port without getting hung up, and preventing the inners sleeve from being depressed prematurely which could prevent engagement.

On the opposite end of the inner sleeve (mounting end), there exists a stepped shoulder which has two functions relating to the inner sleeve spring (601). The first portion is the land (404) for the inner sleeve spring to rest upon and transfer force to the sleeve, and the second is the centralizer (405) or rim formed to keep the spring centered and engaged with the plug. To maintain the center bore's (409) ability to allow a screw to fully pass, the centralizing rim has been located on the outside of the sleeve but could optionally be located inside also.

Along the outside of the sleeve, in particular towards the engagement end, the outer wall forms the surface (406) or barrier to retain the ball bearings in their outward most position. This position is considered the unlocked or cocked position so they do not obstruct a plug from engaging smoothly with the device. One of the most important features of the sleeve is the bore (409) through the center making it a hollow tube. This bore is what makes it unique compared to conventional couplers and is the primary reason the valve has been omitted from the design. Three main functions are achieved by using a sleeve in place of a valve:
1) By removing the restriction in the center, the device can accommodate a greater variety of coupler plugs with different shapes and designs. Without a blockage, the sleeve allows longer plug designs such as the Lincoln style to pass through without obstruction. Allowing the tip of the plug to pass through rather than bottoming out in a valve means the same coupler design can house a larger variety of plug types with the same universal design. Similarly, removing the pressure seals allows wider plug tips such as the V style to enter the device.
2) The second function a hollow sleeve allows for is that a common screw can pass through the sleeve and second body member of the device and lodge deeper inside the first body member to allow for an additional mounting method. It is important for the ID of the bore through the sleeve be large enough to allow the head of a screw to pass fully unobstructed so that the device can function as a tool holder. This bore should also be large enough to accommodate a driver or bit to install the screw.
3) Removing a complicated valve and seals not only reduces cost to produce, but also simplifies design with less moving parts and less parts required overall.

While discussing the hollow pass through, there is another consideration at play. The inner walls of this channel form part of the engagement surface (102) which various plugs interact with in place of a valve. Very careful consideration had to be given for the appropriate sizing of this bore so that it could accommodate all five major types of plugs and it posed one of the greatest design challenges. The bore (209) through second body member of the device had to be large enough to accommodate the largest OD of any plug designed to work with it, but what was challenging was designing the sleeve so it would interact correctly with all five common plugs (more details in FIG. 9). In order for the automatic locking function to work properly, the plug has to enter the second body member and engage with the sleeve (401), then push the sleeve towards the mounting surface, compressing the inner sleeve spring (601) and removing the ball bearing obstruction (406) so that they ball bearings can move in to place and lock on to the plug. If the ID in the sleeve is too large and the plug passes without moving the sleeve, the ball bearings do not move into locking position and the mechanism fails. On the other hand, if the ID of the sleeve is too small, the tip of wider plugs such as V type and T type begin to push the sleeve out of the way prematurely allowing the locking ball bearings to move inward too soon and locking in place preventing the plug from entering. In short, the sleeve has to move out of the way at the correct time allowing the ball bearings to engage behind the larger OD (call it the locking ring) on the plug in order to lock it in place. To achieve this, the ID of the sleeve had to be sized appropriately so that the tip of the wider plug styles (V & T) could pass into the sleeve yet the ID had to be small enough so that the locking ring of all plug types would not pass through. Fortunately the tip of the largest plug was just slightly smaller than the OD of the smallest ring and an optimal bore was configured. The larger bore also allowed the screw to pass.

Within the bore (409), just beyond where the tip of the wider designs reaches, the ID can optionally be reduced (408, shown in FIG. 6) to help centralize and stabilize (407) narrow plugs with longer tips such as the A style and L style even more. Also, this is where moving the location of the tapered ball bearing ports (204) along the second body member can also offer improved stabilization and minimize lateral play in the plug once engaged in the coupler. This stabilization is not critical to the operation of holding the tool securely, but it can reduce movement of the tool once engaged.

The bore is a defining feature of the sleeve, but would not be required for some models or designs of the device that do not use screw mounting from the inside and do not need to accommodate a variety of plugs. Alternatively, a design could feature only a threaded bolt hole, hooks, or an external flange for mounting. These are all viable options but the hollow pass through (099) offers a unique, compact and discrete way to mount the device elegantly and accommodates a greater number of standard plugs. In any scenario, the purpose of the described device remains the same, it should function as a secure tool storage device when attached to a surface or object, and provide the function of a protective cap when used unmounted.

The sleeve length ensures proper operation of the device as well as its automatic locking function, and it can vary depending on: the length of the first body member, the location of the land (207) in the second body member, the desired spring pressure for insertion and ejection, and the required travel distance depending on plug application.

Embodiment 411 shows a sleeve (401) designed with a constant ID through most of its length. The outer wall of the sleeve (410) comes into contact with the ball bearings holding them in their outward position and fits within the inner border of the second body member (209). At the top, the outer chamfer (402) to assist with ball bearing location can be observed. The inner chamfer (403) to guide the plug in can also be seen. The land (404) for the inner spring is visible as well as the retaining ring to centralize (405) the inner sleeve spring (601). Embodiment 412 shows the optional reduction (408) in ID can be observed which helps centralize and stabilize (407) the tips of longer plugs. It should be mentioned, the area with a larger OD just above the reduction is designed to accommodate the wide tip of the V-style plug.

In FIG. 6, the hollow nature of the pass through (409) can be observed which accommodate a screw and driver. In FIGS. 7 & 8, the outer collar (501) is a key component of the coupler holder assembly (101) and is integral in both the retention system and the automatic function of the device. Primarily, the outer collar is in place to interact with the ball bearings (801); allowing them to move towards the outside of the device (away from the center) to their unlocked state, forcing them inward using force from a compressed spring (701) and a chamfer (505) to guide them in to their tapered ports (204), and finally to hold the ball bearings in their inner most locked position with a band of material called a keeper (504) that has a narrower ID than the rest of the collar. By traveling axially along the device within a range confined by features on the first body member (304, 315) and the second body member (205, 208), its movement assisted by the outer collar spring (701) serves to direct and control the movement of the ball bearings between their two primary positions affecting the automatic function of the device. Finally, the outer collar also serves to keep the ball bearings confined within the device so they can not leave their tapered ports (204). Even when the device is cocked and unlocked, and the ball bearings are in their outer most position, they are still contained within the recess (508) under the outer collar.

Beyond manipulating the ball bearings, the outer collar may also have a functional decorative component commonly in the form of knurling (502). This hash-marked portion features a textured surface to provide grip for manually manipulating the outer collar. This knurling is optional and can exist in many patterns as seen in FIG. 12. Opposed to the knurling are often areas with a smooth finish (503) which can be used to break up the decorative pattern, or optionally may provide a place for information to be contained. This is often done with engraving, laser etching or stamping and can contain information such as the types of plugs it will interact with, manufacturer information, or any other useful data.

In order to assist the locking function of the device and prevent a plug from unintentionally becoming disengaged, the outer collar spring (701) continually applies force against a land (506) located on the inside of the collar. The spring which pushes against the first body member (305), is continually in various states of compression and applies a force to the outer collar at all times. When unlocked, the force causes an inserted plug to be automatically locked in place and when locked, it serves to hold the outer collar in its locked state against the flange (205) on the second body member to ensure the device doesn't unlock accidentally. Only when the collar is manually manipulated and cocked back will an engaged plug disengage and this resets the spring for the next use. The collar itself is in the form of a tube and is kept in position by encompassing the first and second body members within its hollow center thru (507).

Overall the device as described would not function without this component unless a significant change in design was considered. It should be mentioned that while the outer collar facilitates the automatic function allowing a user to simply push a tool into the coupler and it locking automatically, the collar is also useful in manual versions of the device. In short, the manual version of the device does not rely on an inner sleeve to push the ball bearings outward and hold them there until a plug is received. In the manual operation, the outer collar is kept in its locked position at all times by the collar spring holding the locking ball bearings inward. In order to engage a plug with the coupler, a user has to manually slide the collar back to the unlocked position and hold it there while a plug is inserted, the plug itself pushes the ball bearings back out of the way rather than the inner sleeve, and once the plug is fully engaged, the outer collar is released, forced back to its locked position by the spring against the flange (205)

The described device does not require automatic function for it to fulfill its purpose as an effective tool storage solution. However, the added convenience of not having to manipulate the collar to secure a tool in place adds value to the end user and is a feature that should be preserved when possible.

In this embodiment, the first body member (301) exterior is in hex form (302), and forms the half of the device that would normally come into contact with a surface or object (103). A two banded knurled surface appears on the outer collar (501) and from the collar position being cocked back towards the mounting surface, one can see it is of the automatic function variety. This collar represents the outermost portion of the retention system as it controls the movement of the locking ball bearings. Opposite the mounting surface is the engagement surface (102) located on the other half of the second body member (201).

FIG. 12 shows various external patterns on the device. Feature 511 features five evenly spaced, even width bands of the knurling finish, primarily as decoration. Feature 512 shows an example of 5 evenly spaced bands of various width, and feature 513 shows a single wide band of knurling with additional grooves in the collar for grip. Knurling is the cross-hatch pattern stamped into a metal (in this case) surface leaving a decorative and textured surface. This texture allows a user to grip the collar more easily and apply lateral force. The optional knurling of the collar can include any number of bands, spacing or patterns. The knurling can also be used to contrast smooth sections of the band (105) which can also contain text or other information stamped, etched or engraved.

FIG. 9 shows the device interfacing with various attachment standards. Specifically, it illustrates how the device (101) interacts with five popular male plug types, how those plugs interact with the sleeve (401), and the position of the sleeve and locking balls (801) within the device when engaged and locked on to the plugs.

Embodiment 701 shows the device in its cocked and unlocked position ready to receive a male plug. The inner sleeve is furthest towards the engagement surface (102) up against the land (207). In this state, the inner sleeve spring (601) is extended to its fullest extent and exerts the least force on the sleeve.

Embodiment 702 shows the popular M type of plug engaged with the device. Notice the tip of the plug enters the hollow pass thru (409) portion of the sleeve before the locking ring comes into contact with the chamfer of the sleeve (403). Once these surfaces are in contact, engaging the plug further into the coupler begins to move the sleeve axially towards the mounting surface of the device compressing the spring. Once the sleeve has moved out of the way of the tapered ports (204) containing the ball bearings, the bearings are forced inward by the spring pressure (701) on the outer collar (501) and the chamfer (505) forces the balls inward to their locking position behind the locking ring on the plug. With the collar in its fully locked position against the flange (205), the keeper (504) holds the ball bearings (801) firmly locking the plug in place until it is intentionally released.

The same locking mechanism is used across all plug designs although the way they interact with the sleeve varies. Embodiment 703 shows the T style engaged with the device. The tip of the plug does not extend very far in to the sleeve before it begins to move the sleeve back exposing the ball bearings. Overall, the sleeve has to travel a greater distance in order for the ball bearings to lock behind the locking ring on the plug. By comparison to the M style plug, the sleeve has been moved further. The ball bearings also come in contact with the wider retaining ring prior to dropping in to place. If the plug is not fully inserted, the chamfer on the outside of the sleeve assists in resetting the ball bearings.

Embodiment 704 shows the widest V style plug, the OD of the tip of the plug still fits within the ID of the top of the sleeve by design. Allowing the tip to engage in the sleeve before the sleeve is pushed back allows the balls to engage in the correct position. If the tip did not fit inside sleeve, the sleeve would be pushed out of the way and the ball bearings would close in to the inner bore (209) prematurely preventing the plug from engaging. The chamfer (403) on the inside of the sleeve helps guide the V style plug in since the tolerances are quite close.

Embodiment 705 shows the long Lincoln L style plug in its locked position. The tip of the plug can be seen extending beyond the end of the sleeve which is why it is important the sleeve have a hollow bore (409). The OD of the L style plug tip is the narrowest of all types which results in some lateral movement of the plug when engaged. In this case, the inner surface of the sleeve serves to stabilize (407) the plug and can further be stabilized with an option reduction in ID (408) as seen in FIG. 6. Finally note that the end of the L style plug when fully inserted still allows enough clearance between the bottom of the bore (307) within the first body member that a screw can reside inside with plenty of room for the head recessed in the countersink (303).

Finally, embodiment 706 shows the A style plug fully engaged. The tip is able to enter into the sleeve and the sleeve is not forced back releasing the locking balls until the locking ring contacts the sleeve. The longer tip also could benefit from a reduction in ID of the sleeve for stabilization although the lateral play is minimal and acceptable. In all of the examples there is sufficient clearance in the bottom of the first body member bore (307) for a screw. Also, if the device is mounted with a bolt, the bolt may extend into the bore providing some flexibility in the length of fastener while ensuring all threads are fully engaged for maximum strength.

FIG. 10 shows an example of an optional mounting surface (103) on the first body member that is angled and not perpendicular to the Z-axis of the device. Depending on the installation, the orientation and trajectory of the mounting bore (312) may also change and optionally no longer be in line with the Z-axis of the device.

FIG. 11 shows an example of the device (101) with an external mounting flange (313) located along the mounting surface (103) on the first body member (301). This is just an example, the flange could also be located in numerous orientations, come in multiple forms and accommodate a broad number and type of different fasteners although the picture here shows two screw or bolt holes flanking the first body member (301).

The length of the inner sleeve is quite important for proper operation finding a balance between being long enough to reach its seated position when the inner sleeve spring is fully extended, having enough travel to accommodate all of the various plug lengths it is designed to hold, and generating enough resistance/force to accept and eject inserted plugs. If the device is designed to hold only one short plug and not be universal, the length of the first body member (301) can be shortened which means the inner sleeve will have to be shortened also. This may be desirable to reduce the length of the overall device for a lower profile installation and to reduce the leverage on the device when installed horizontally.

Different features, variations, and embodiments are shown and described. What has been described in this application at times in terms of specific embodiments is done for illustrative purposes only and without the intent to limit or suggest that what has been conceived is only one particular embodiment or specific embodiments. This disclosure is not limited to any single specific embodiments or enumerated variations. Many modifications, variations and other embodiments will come to mind of those skilled in the art, and which are intended to be and are in fact covered by this disclosure. The scope of this disclosure should be determined by a proper legal interpretation and construction of the disclosure, including equivalents, as understood by those of skill in the art relying upon the complete disclosure present at the time of filing. For purposes of this disclosure, including claims, plurality means one or more.

### BRIEF DESCRIPTION OF DRAWINGS

FIG. 1 is a diagram illustrating a side view with cutaways of the various components making up a version of a pneumatic coupler tool storage device. An assembled version can also be seen.

FIG. 2 is a diagram illustrating an example of the first body member portion of the device and its features.

FIG. 3 is a diagram illustrating an example of the second body member portion of the device and its features.

FIG. 4 is a diagram illustrating various common components of the device.

FIG. 5 is a diagram illustrating an example of the inner sleeve of the device and its features.

FIG. 6 is a diagram illustrating two examples of inner sleeve variations within the device and their features.

FIG. 7 is a diagram illustrating an example of the outer collar on the device and its features.

FIG. 8 is a diagram illustrating an example of the complete assembly and some of its features.

FIG. 9 illustrates the device interacting with five popular male plug types.

FIG. 10 is a diagram illustrating an example of an optional mounting surface on the first body member that is angled and not perpendicular to the Z-axis of the device.

FIG. 11 is a diagram illustrating the device with an external mounting flange.

FIG. 12 is a diagram illustrating three different examples of the outer collar and variations of knurling.

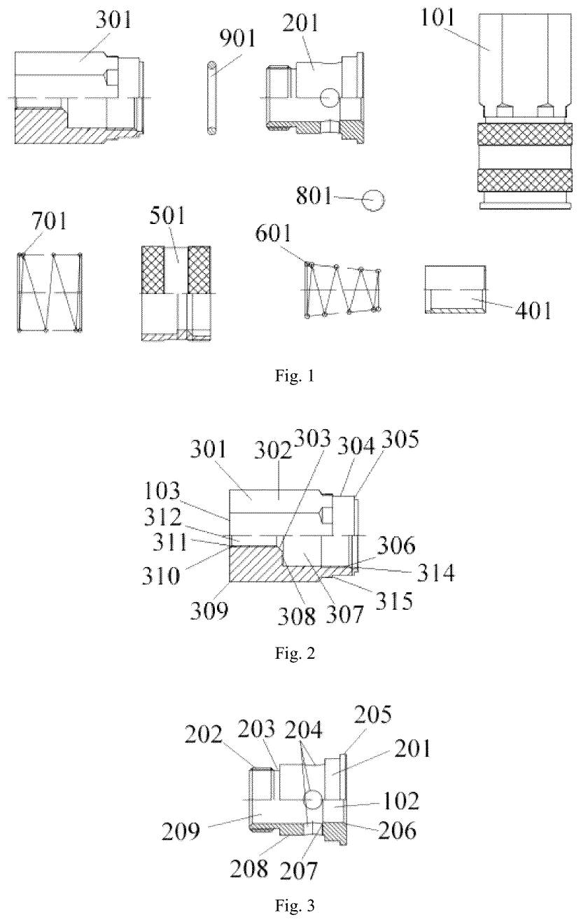

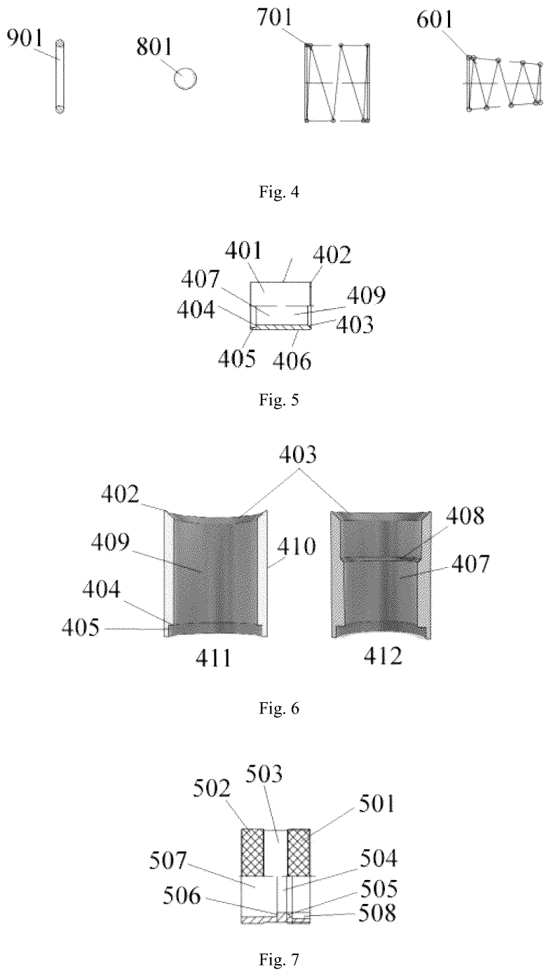

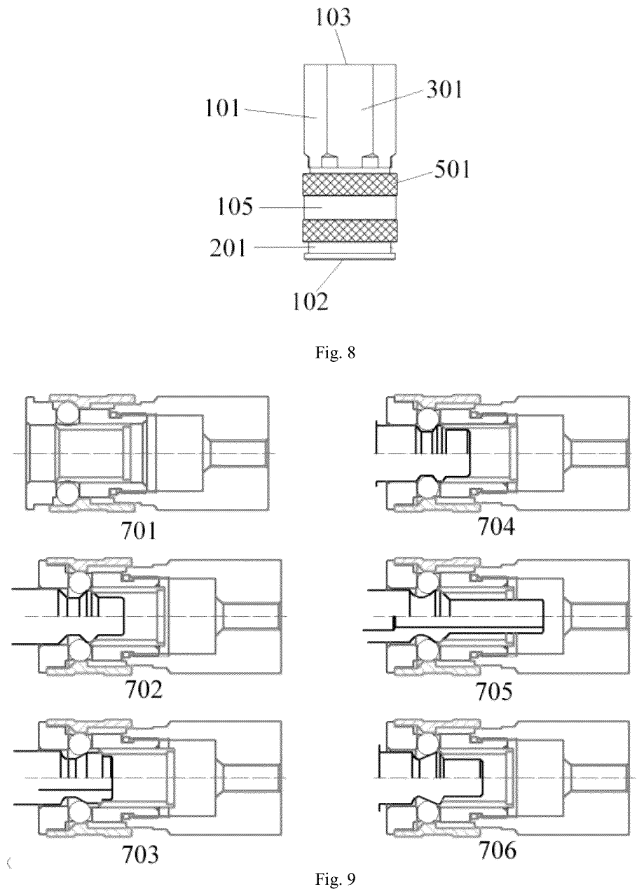

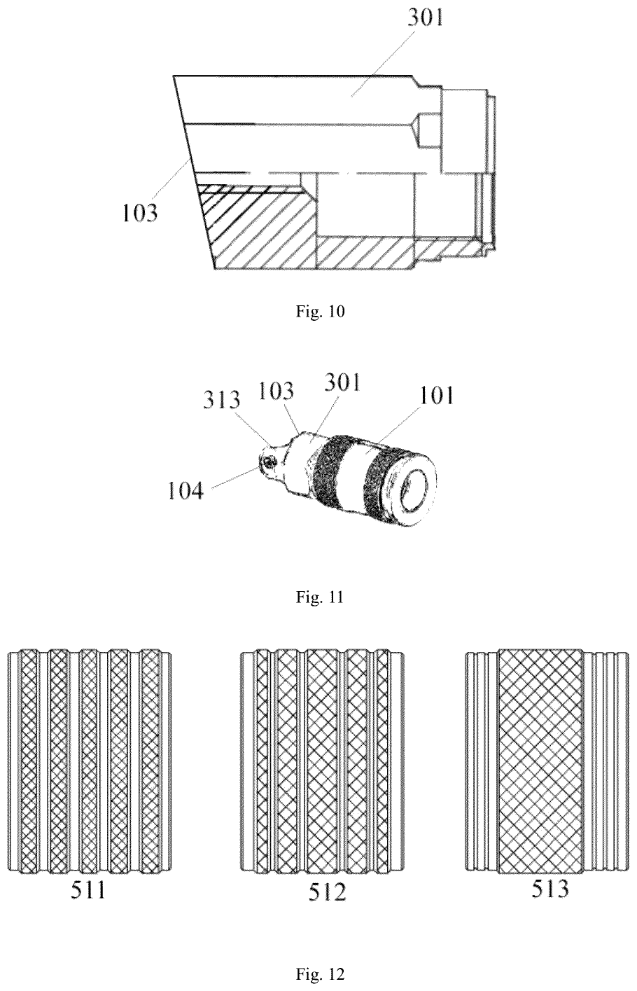

### DESCRIPTION OF EMBODIMENTS

The apparatus is preferably attached to surface. The surface preferably has a hole large enough for the shank of a bolt to pass through but prevent the head of the bolt from passing through. A bolt is passed through from the back side of the surface. The first body member of the apparatus is then screwed onto the bolt thereby attaching the apparatus to the surface. The apparatus is biased by the outer collar biasing member in a configuration with the outer collar retracted.

A device is inserted into the apparatus depressing the inner sleeve. The movement of the inner sleeve vacates space for the ball bearings to move toward the center of the second body member and into a reduced diameter portion of the plug thereby interfering with the removal of the plug from the apparatus. As the ball bearings move toward the center of the second body member, the spring displaces the outer collar which occupies space outside the ball bearings thereby keeping the ball bearings in an interfering position.

To remove a device from the apparatus, pressure is applied to the outer collar creating space around the ball bearings in the second body member. The device is then withdrawn from the apparatus. As the device is withdrawn, the inner spring displaces the inner sleeve into a cocked position such that the apparatus is ready for a device to be re-inserted.

### INDUSTRIAL APPLICABILITY

The apparatus has particular applicability in workshops where users need to store, track, and use various pneumatic tools. The apparatus allows a user to attach each of their tools to a series of apparatuses thereby storing them in a convenient and accessible location and easily retrieve a needed tool for use.

1. An apparatus for connecting a device to a surface comprising:
A. a first body member, having a lengthwise internally threaded aperture, attachable to a surface wherein:
i. the threads are parallel threads,
B. a second body member configured to accept a device:
i. attachable to the first body member and
ii. having a plurality of voids configured to accept retention means,
C. a plurality of means for, when engaged, selectably retaining a device in the apparatus,
D. an outer collar, and
E. an outer collar biasing mechanism configured to bias the outer collar in an extended configuration.

2. The apparatus of claim 1 wherein:
A. the threads of the aperture of the first body member are engageable from at least two ends of the aperture.

3. The apparatus of claim 2 wherein:
A. an opening of the aperture is chamfered to a diameter greater than the major diameter of the threads adjacent the opening in the lengthwise aperture.

4. The apparatus of claim 3 wherein:
A. the second body member is attachable to the first body member by a series of threads on the first body member and a series of threads on the second body member.

5. An apparatus for connecting a device to a surface comprising:
A. a first body member attachable to a surface,
B. a second body member configured to accept a device:
i. attachable to the first body member and
ii. having a plurality of voids configured to accept a plurality of means for retaining a device in the apparatus,
C. a plurality of means for, when engaged, selectably retaining a device in the apparatus,
D. an inner sleeve,
E. an inner sleeve biasing mechanism configured to bias the inner sleeve in an extended configuration,
F. an outer collar, and
G. an outer collar biasing mechanism configured to bias the outer collar in an extended configuration.

6. The apparatus of claim 5 wherein:
A. the inner sleeve is sized such that a device inserted into the apparatus contacts and depresses the inner sleeve when the device is inserted.

7. The apparatus of claim 6 wherein:
A. the minimum cross sectional area of the plurality of voids is less than the maximum cross sectional area of the plurality of means for retaining a device in the apparatus.

8. The apparatus of claim 7 wherein:
A. the outer collar, when in an extended configuration, engages the plurality of means for retaining a device in the apparatus and
B. the outer collar, when not in an extended configuration, does not engage the plurality of means for retaining a device in the apparatus.

9. The apparatus of claim 7 wherein:
A. the plurality of voids in the second body member are radial.

10. The apparatus of claim 9 wherein:
A. the plurality of voids in the second body member comprise frustums of a cone having a cross sectional surface area which reduces toward the center of the apparatus.

11. The apparatus of claim 10 wherein:
A. the plurality of retention means are spherical.

12. The apparatus of claim 7 wherein:
A. the inner sleeve, in an extended configuration, covers at least a portion of the voids.

13. The apparatus of claim 5 wherein:
A. the second body member is attachable to the first body member by a series of threads on the first body member and a series of threads on the second body member.

14. An apparatus for connecting a device to a surface comprising:
A. a first body member, having a lengthwise aperture, attachable to a surface wherein:
i. an opening of the aperture is chamfered to a diameter greater than the greater of the diameter and the major diameter of any threading adjacent the opening in the lengthwise aperture,
B. a second body member configured to accept a device:
i. attachable to the first body member and
ii. having a plurality of voids configured to accept retention means,
C. a plurality of means for, when engaged, selectably retaining a device in the apparatus,
D. an outer collar, and
E. an outer collar biasing mechanism configured to bias the outer collar in an extended configuration.

15. The apparatus of claim 14 wherein:
A. the lengthwise aperture of the first body member is internally threaded.

16. The apparatus of claim 15 wherein:
A. the threads of the lengthwise aperture of the first body are parallel threads.

17. The apparatus of claim 14 wherein:
A. the first body member is attachable to the surface by means of a plurality of flanges attached to the first body member.

18. The apparatus of claim 14 wherein:
A. the second body member is attachable to the first body member by a series of threads on the first body member and a series of threads on the second body member.
